(19) United States
(12) Patent Application Publication
(10) Pub. No.: US 2026/0066301 A1
(43) Pub. Date: Mar. 5, 2026

(54) DUAL-BINDER ENABLED CALENDERED SEMI-DRY ELECTRODE

(71) Applicant: GM GLOBAL TECHNOLOGY OPERATIONS LLC, Detroit, MI (US)

(72) Inventors: Dewen KONG, Shanghai (CN); Haijing LIU, Shanghai (CN); Meiyuan WU, Shanghai (CN); Xin ZHANG, Shanghai (CN)

(21) Appl. No.: 18/924,351

(22) Filed: Oct. 23, 2024

(30) Foreign Application Priority Data
Sep. 5, 2024 (CN) 2024112423443

(51) Int. Cl. H01M 4/62; H01M 50/46

(52) U.S. Cl. CPC H01M 4/623; H01M 50/46

(57) ABSTRACT

A battery cell includes A anode electrodes, C cathode electrodes, and S separators where C, A and S are integers greater than one. The C cathode electrodes each include a cathode current collector and a cathode active material layer arranged on the cathode current collector. The cathode active material layer comprises a cathode active material, a conductive filler, and a binder including a fibrillating binder and a co-polymer including polyacrylonitrile (PAN) and polyacrylic acid (PAA).

### CROSS-REFERENCE TO RELATED APPLICATIONS

This application claims the benefit of Chinese Patent Application No. 202411242344.3, filed on Sep. 5, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a cathode electrode including a cathode active material layer comprising cathode active material, a conductive filler, and a dual-binder including a fibrillating binder and a co-polymer.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A battery cell includes A anode electrodes, C cathode electrodes, and S separators where C, A and S are integers greater than one. The C cathode electrodes each include a cathode current collector and a cathode active material layer arranged on the cathode current collector. The cathode active material layer comprises a cathode active material, a conductive filler, and a binder including a fibrillating binder and a co-polymer including polyacrylonitrile (PAN) and polyacrylic acid (PAA).

In other features, the cathode active material layer comprises the cathode active material in a range from 84 wt % to 98.7 wt %, the conductive filler in a range from 0.5 wt % to 10 wt %, the fibrillating binder in a range from 0.5 wt % to 5 wt %, and the co-polymer in a range from 0.1 wt % to 1.5 wt %.

In other features, the cathode active material comprises a material selected from a group consisting of NCM, NCMA, NMx, LFP, LMFP, and combinations thereof. The fibrillating binder includes polytetrafluoroethylene (PTFE).

In other features, hydrogen in a carboxyl (COOH) of the PAA is at least partially substituted by a lithium ion via reaction with a lithium-based chemical to form PAA LiₓH₁₋ₓ (0<x<1). Hydrogen in a carboxyl (COOH) of the PAA is at least partially substituted by sodium ion via reaction with a sodium-based chemical to form PAA LiₓH₁₋ₓ (0<x<1).

In other features, a porosity of the cathode active material layer is in a range from 20% to 60%. A porosity of the cathode active material layer is in a range from 25% to 35%.

In other features, a press density is in a range from 1.0 to 3.7 g/cc. The cathode active material layer is attached to the cathode current collector without using conductive glue.

In other features, the conductive filler includes a carbon based conductive filler selected from a group consisting of a carbon black, graphite, graphene, graphene oxide, Super P, acetylene black, Ketjen black (KB), single walled carbon nanotubes (SWCNT), multi-walled carbon nanotubes (MWCNT), carbon nanotubes, and combinations thereof. The conductive filler includes a non-carbon based conductive filler selected from a group consisting of a simple oxide, a superconductive oxide, a carbide, a silicide, and combinations thereof.

A battery cell includes A anode electrodes, C cathode electrodes, and S separators where C, A and S are integers greater than one. The C cathode electrodes each include a cathode current collector and a cathode active material layer arranged on the cathode current collector. The cathode active material layer comprises a cathode active material selected from a group consisting of NCM, NCMA, NMx, LFP, LMFP, and combinations thereof, a conductive filler, and a binder including polytetrafluoroethylene (PTFE) and a co-polymer including polyacrylonitrile (PAN) and polyacrylic acid (PAA). The cathode active material layer is attached to the cathode current collector without using conductive glue.

In other features, the cathode active material layer comprises the cathode active material in a range from 84 wt % to 98.7 wt %, the conductive filler in a range from 0.5 wt % to 10 wt %, the PTFE in a range from 0.5 wt % to 5 wt %, and the co-polymer in a range from 0.1 wt % to 1.5 wt %.

In other features, hydrogen in a carboxyl (COOH) of the PAA is at least partially substituted by a lithium ion via reaction with a lithium-based chemical to form PAA LiₓH₁₋ₓ (0<x<1). Hydrogen in a carboxyl (COOH) of the PAA is at least partially substituted by sodium ion via reaction with a sodium-based chemical to form PAA LiₓH₁₋ₓ (0<x<1).

In other features, a porosity of the cathode active material layer is in a range from 20% to 60%. A porosity of the cathode active material layer is in a range from 25% to 35%. A press density is in a range from 1.0 to 3.7 g/cc.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell including C cathode electrodes, A anode electrodes, and S separators according to the present disclosure;

FIG. 2 is a side cross section of an example of a cathode electrode according to the present disclosure;

FIG. 3 is a side cross section of an example of an anode electrode according to the present disclosure;

FIG. 4 is a graph showing an example of adhesive force to separate the cathode active material layer from the cathode current collector according to the present disclosure;

FIG. 5 is a graph showing an example of voltage as a function of capacity for half coin cells according to the present disclosure; and

FIG. 6 is a graph showing an example of discharge capacity as a function of cycles for half coin cells according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

A polytetrafluoroethylene (PTFE) binder-based, free-standing cathode active material layer may be manufactured using a roll-to-roll process. The free-standing cathode active material layer may be dried in an oven and then laminated onto a current collector using intaglio printing and a liquid conductive glue. After intaglio printing, the cathode electrode is dried in an oven and then collected onto a roll. The cost of manufacturing is high due to the use of intaglio printing and a recovery system that may be required during both lamination and drying (e.g., when using lithium ion phosphate (LFP) as the cathode active material). When glued, the cathode active material layer has 180° peeling force of 140 N/m.

The present disclosure relates to a cathode electrode including a cathode active material layer comprising a cathode active material (e.g., such as LFP or other active material), a conductive filler, and a dual binder system including a fibrillating binder and a co-polymer including polyacrylonitrile (PAN) and polyacrylic acid (PAA) (e.g., PAN-PAA co-polymer). The cathode active material layer is manufactured as a free-standing film and then directly calendared onto a current collector without using an intaglio printing process or conductive glue.

In some examples, the fibrillating binder includes polytetrafluoroethylene (PTFE). In some examples, the cathode active material layer includes PTFE in a range from 0.5 wt % to 5 wt %. In some examples, the cathode active material layer includes the PAN-PAA co-polymer in a range from 0.1 wt % to 1.5 wt %.

The fibrillated PTFE binder is used to host active material particles and construct a 3D binding network in the free-standing film. The PAN-PAA polymer has tailored functional groups to generate robust adhesive force between free-standing film and the current collector using a warm/hot calendaring process. In some examples, the warm process has a temperature in a range from 20° C. to 50° C. In some examples, the hot process has a temperature in a range from 50° C. to 200° C.

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. Liquid electrolyte 52 is added to the enclosure 50.

The C cathode electrodes 20-1, 20-2, . . . , and 20-C include a cathode active material layer 24 arranged on one or both sides of a cathode current collector 26. The A anode electrodes 40-1, 40-2, . . . , and 40-A include anode active material layers 42 arranged on one or both sides of the anode current collectors 46. The S separators 32-1, 32-2, . . . , and 32-S are arranged between the C cathode electrodes 20 and the A anode electrodes 40.

In some examples, the A anode electrodes 40 and the C cathode electrodes 20 exchange lithium ions during charging/discharging. In some examples, the cathode active material layers 24 and/or the anode active material layers 42 comprise coatings including one or more active materials, one or more conductive fillers, and/or one or more binder materials that are cast or applied onto one or both sides of the cathode current collector 26 and/or the anode current collector 46.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. In some examples, the current collector is coated with carbon. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

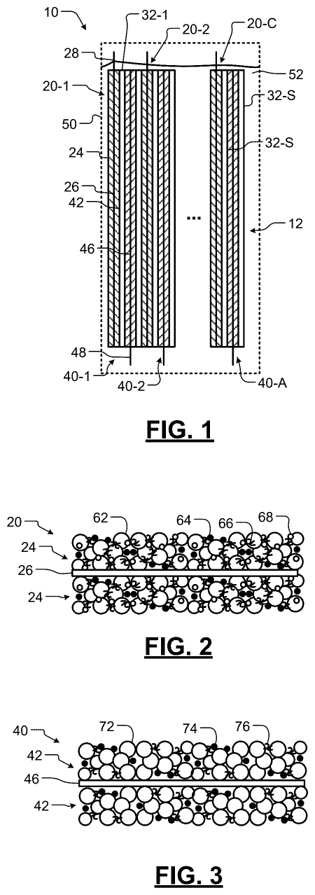

Referring now to FIG. 2, one of the C cathode electrodes 20 is shown in more detail. The cathode active material layer 24 includes a cathode active material 62, a conductive filler 64, a first binder 66 including a fibrillating binder, and a second binder 68 including the PAN-PAA co-polymer.

In some examples, the cathode active material layer comprises the cathode active material in a range from 84 wt % to 98.7 wt %, the conductive filler in a range from 0.5 wt % to 10 wt %, the fibrillating binder in a range from 0.5 wt % to 5 wt %, and the PAN-PAA co-polymer in a range from 0.1 wt % to 1.5 wt %. In some examples, the cathode active material comprises lithium nickel cobalt manganese (NCM), lithium nickel cobalt manganese aluminum (NCMA), lithium nickel metal (NMx), lithium iron phosphate (LFP), lithium manganese iron phosphate (LMFP), and combinations thereof.

In some examples, the areal capacity of the cathode electrode is in a range from 2.5 to 10 mAh/cm². In some examples, the areal capacity of the cathode electrode is in a range from 3.5 to 4 mAh/cm². In some examples, the areal capacity variation is in a range of +/−3%.

In some examples, the press density is in a range from 1.0 to 3.7 g/cc. In some examples, the press density for LFP is in a range from 2.0 to 2.7 g/cc with a press density variation in a range of +/−3%. In some examples, the press density for NCM is in a range from 3.0 to 3.7 g/cc with a press density variation in a range of +/−3%. In some examples, the porosity of the cathode active material layer is in a range from 20% to 60%. In some examples, the porosity of the cathode active material layer is in a range from 25% to 35%.

In some examples, the conductive filler includes a carbon-based conductive filler and/or a non-carbon based conductive filler. In some examples, the carbon based conductive filler is selected from a group consisting of a carbon black, graphite, graphene, graphene oxide, Super P, acetylene black, Ketjen black (KB), single walled carbon nanotubes (SWCNT), multi-walled carbon nanotubes (MWCNT), carbon nanotubes, and other electronically conductive fillers. In some examples, the non-carbon based conductive filler is selected from a group consisting of oxide (e.g., ruthenium oxide (RuO₂), tin oxide (SnO₂), zinc oxide (ZnO), germanium oxide (Ge₂O₃), superconducting oxide (e.g., YBa₂Cu₃O₇, La_{0.75}Ca_{0.25}MnO₃), carbide (e.g., SiC₂), silicide (e.g., MoSi₂), and combinations thereof.

In some examples, a structure of the PAN-PAA co-polymer is:

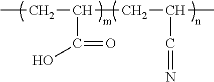

In some examples, the hydrogen on the carboxyl (COOH) of the PAA is fully or partially substituted by a lithium ion (Lit) via reaction with a lithium-based chemical (e.g., such as lithium hydroxide (LiOH)) to form PAA LiₓH₁₋ₓ (0≤x≤1). In some examples, the hydrogen on the carboxyl (COOH) of the PAA is fully or partially substituted by a sodium ion (Na⁺) via reaction with a sodium-based chemical (e.g., such as sodium hydroxide (NaOH)) to form PAA NaₓH₁₋ₓ (0≤x≤1).

In some examples, the polymers can be powdered, dispersion, or solution. In some examples, the solid content is in a range from 2 to 25 wt % for dispersion or solution. In some examples, the solid content is in a range from 10 to 20 wt % for dispersion or solution. In some examples, the PTFE is dispersed in an aqueous solution. In some examples, the PTFE comprises 10 wt % to 60 wt %. In some examples the PTFE molecular weight is greater than 5M.

Referring now to FIG. 3, one of the A anode electrodes 40 is shown in more detail. The anode active material layer 42 includes an anode active material 72, a conductive filler 74, and a binder 76. In some examples, the anode active material 72 is selected from a group consisting of graphite, carbon, silicon-carbon, silicon oxide (SiOₓ), lithiated silicon oxide (LSO), a graphite blend, and combinations thereof.

In an example implementation, a PAN-PAA solution is mixed with a solvent such as glycol. The PAN-PAA and glycol mixture is added to a mixture of the active material, the conductive filler, and the PTFE binder. In some examples, the cathode active material layer includes LFP at 95.5 wt %, the PTFE binder at 2 wt %, the conductive filler includes SP at 1 wt % and KB at 1 wt %, and the PAA-PAN at 0.5 wt %. A mixture including the active material, the conductive filler, the PTFE, the PAN-PAA, and glycol mixture was pressed and heated to form a free-standing film. The free-standing film was dried in an oven. The dried free-standing film was laminated onto the cathode current collector (e.g., a 20 μm aluminum foil) by pressing and heating the dried free-standing film and the cathode current collector at 25° C. and 500 psi. Conductive glue was not used.

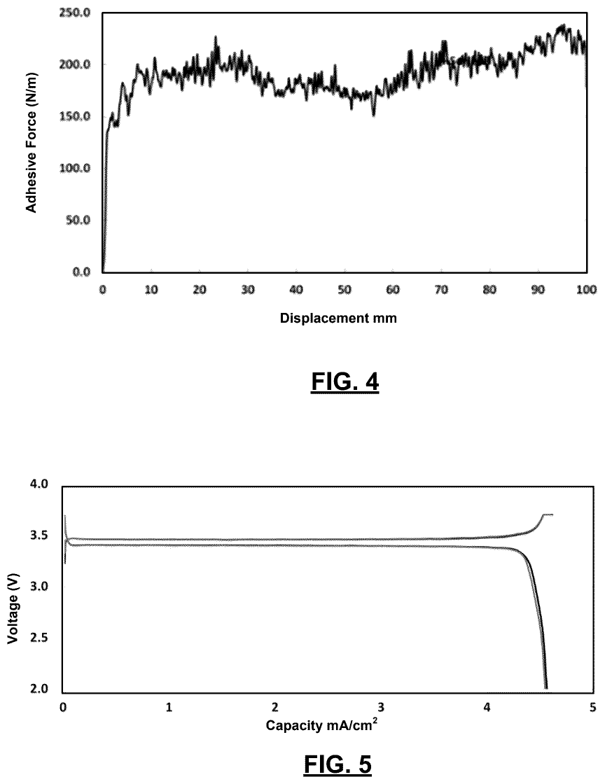

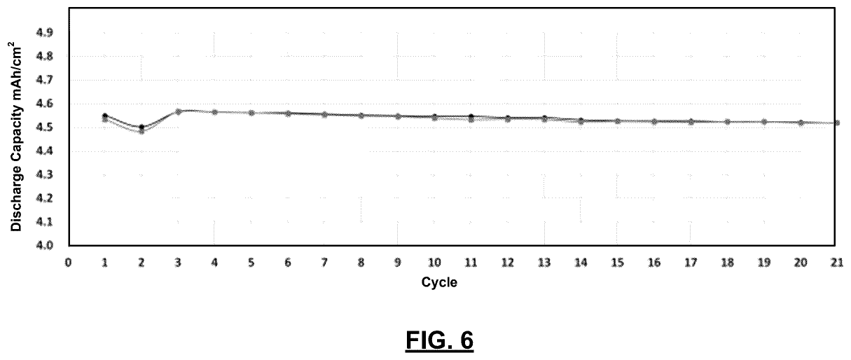

Referring now to FIGS. 4 to 6, performance of the example cathode electrode is shown. In FIG. 4, the cathode active material layer required 194 N/m of force for removal from the cathode current collector. In FIG. 5, the first cycle performance of the cathode electrode (e.g., a half coin cell) is shown at 25° C. The operating range of the battery cell was 2.0 V to 3.7 V. Charging included constant current, constant voltage (CCCV) charging with a C/50 taper. In FIG. 6, discharge capacity is shown as a function of cycles for the half coin cells.

As can be appreciated, the battery cells can be manufactured without using the intaglio printing process and/or the recovery system, which reduces cost. The cathode active material layer is attached to the cathode current collector with the same or higher adhesion force as compared to cathode electrodes manufactured using the intaglio printing process.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery cell comprising:
A anode electrodes;
C cathode electrodes each including a cathode current collector and a cathode active material layer arranged on the cathode current collector; and
S separators, where C, A and S are integers greater than one,
wherein the cathode active material layer comprises:
a cathode active material;
a conductive filler; and
a binder including a fibrillating binder and a co-polymer including polyacrylonitrile (PAN) and polyacrylic acid (PAA).

2. The battery cell of claim 1, wherein the cathode active material layer comprises:
the cathode active material in a range from 84 wt % to 98.7 wt %,
the conductive filler in a range from 0.5 wt % to 10 wt %,
the fibrillating binder in a range from 0.5 wt % to 5 wt %, and
the co-polymer in a range from 0.1 wt % to 1.5 wt %.

3. The battery cell of claim 1, wherein the cathode active material comprises a material selected from a group consisting of NCM, NCMA, NMx, LFP, LMFP, and combinations thereof.

4. The battery cell of claim 1, wherein the fibrillating binder includes polytetrafluoroethylene (PTFE).

5. The battery cell of claim 1, wherein hydrogen in a carboxyl (COOH) of the PAA is at least partially substituted by a lithium ion via reaction with a lithium-based chemical to form PAA LiₓH₁₋ₓ (0≤x≤1).

6. The battery cell of claim 1, wherein hydrogen in a carboxyl (COOH) of the PAA is at least partially substituted by sodium ion via reaction with a sodium-based chemical to form PAA LiₓH₁₋ₓ (0≤x≤1).

7. The battery cell of claim 1, wherein a porosity of the cathode active material layer is in a range from 20% to 60%.

8. The battery cell of claim 1, wherein a porosity of the cathode active material layer is in a range from 25% to 35%.

9. The battery cell of claim 1, wherein a press density is in a range from 1.0 to 3.7 g/cc.

10. The battery cell of claim 1, wherein the cathode active material layer is attached to the cathode current collector without using conductive glue.

11. The battery cell of claim 1, wherein the conductive filler includes a carbon based conductive filler selected from a group consisting of a carbon black, graphite, graphene, graphene oxide, Super P, acetylene black, Ketjen black (KB), single walled carbon nanotubes (SWCNT), multi-walled carbon nanotubes (MWCNT), carbon nanotubes, and combinations thereof.

12. The battery cell of claim 1, wherein the conductive filler includes a non-carbon based conductive filler selected from a group consisting of a simple oxide, a superconductive oxide, a carbide, a silicide, and combinations thereof.

13. A battery cell comprising:
A anode electrodes;
C cathode electrodes each including a cathode current collector and a cathode active material layer arranged on the cathode current collector; and
S separators, where C, A and S are integers greater than one,
wherein the cathode active material layer comprises:
a cathode active material selected from a group consisting of NCM, NCMA, NMx, LFP, LMFP, and combinations thereof;
a conductive filler; and
a binder including polytetrafluoroethylene (PTFE) and a co-polymer including polyacrylonitrile (PAN) and polyacrylic acid (PAA), and
wherein the cathode active material layer is attached to the cathode current collector without using conductive glue.

14. The battery cell of claim 13, wherein the cathode active material layer comprises:
the cathode active material in a range from 84 wt % to 98.7 wt %,
the conductive filler in a range from 0.5 wt % to 10 wt %,
the PTFE in a range from 0.5 wt % to 5 wt %, and
the co-polymer in a range from 0.1 wt % to 1.5 wt %.

15. The battery cell of claim 13, wherein hydrogen in a carboxyl (COOH) of the PAA is at least partially substituted by a lithium ion via reaction with a lithium-based chemical to form PAA LiₓH₁₋ₓ (0≤x≤1).

16. The battery cell of claim 13, wherein hydrogen in a carboxyl (COOH) of the PAA is at least partially substituted by sodium ion via reaction with a sodium-based chemical to form PAA LiₓH₁₋ₓ (0≤x≤1).

17. The battery cell of claim 13, wherein a porosity of the cathode active material layer is in a range from 20% to 60%.

18. The battery cell of claim 13, wherein a porosity of the cathode active material layer is in a range from 25% to 35%.

19. The battery cell of claim 13, wherein a press density is in a range from 1.0 to 3.7 g/cc.
